(19) United States
(12) Patent Application Publication
(10) Pub. No.: US 2005/0253370 A1
(43) Pub. Date: Nov. 17, 2005

(54) Coated seat belt device part and method

(75) Inventors: Shigetsugu Nakamura, Shiga (JP); Ichiro Horide, Shiga (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/110,788

(22) Filed: Apr. 21, 2005

Related U.S. Application Data
(60) Provisional application No. 60/570,069, filed on May 12, 2004.

(51) Int. Cl. B60R 22/00

(52) U.S. Cl. 280/801.1

(57) ABSTRACT

A seat belt device part includes a substrate and a coating disposed on a portion of the substrate. The coating is configured to contact a seat belt webbing. The coating is formed of a material configured to be deposited on the substrate by a powder coating process.

### CROSS REFERENCE TO RELATED APPLICATIONS

This application claims priority to and the benefit of U.S. Provisional Application No. 60/570,069, filed May 12, 2004, incorporated by reference herein.

### BACKGROUND

The present invention relates to seat belt devices and, more particularly, to seat belt device parts that interact with a seat belt webbing.

As shown in FIGS. 5A and 5B, a conventional seat belt device part that interacts with a seat belt webbing may be a seat belt tongue 100 for connecting a seat belt webbing to a buckle. The seat belt tongue 100 includes a substrate 120 and a coating 130. The substrate 120 has a portion 120a configured to engage a seat belt buckle, a portion 120b to be coated with the coating 130, and an aperture 120c. The coating 130 is disposed on the portion 120b of the substrate to form a grip portion 130b that is gripped by a hand of a user when inserting the uncoated portion 120a of the substrate into the buckle and an aperture 130c through which the seat belt webbing slides. The aperture 130c coincides with the aperture 120c and is shaped (i.e., length, width, thickness) so that the seat belt webbing is prevented from twisting in the aperture 130c.

The substrate 120 is conventionally formed of a base metal (e.g., steel) to which one or more layers of nickel (i.e., “Ni”) is/are applied. An outer layer of sexivalent chrome is typically applied to the layers of Ni to complete the plating of the base metal. The coating 130 is formed by applying a polymer material (e.g., thermoplastic or thermoset resin) to the portion of the part that interacts with (i.e., contacts) the seat belt webbing to form a surface that enables the webbing to run smoothly over the part. The polymer material is conventionally applied by injection molding.

A conventional method of plating and coating the seat belt device part is now described. A base metal is degreased, subjected to water washing, subjected to acid pickling, and again subjected to water washing. A semi-bright finish layer of Ni is plated onto the base metal. The once-plated base metal is then allowed to cool (i.e., recover). A bright finish layer of Ni is plated onto the semi-bright layer of Ni, and the twice-plated base metal is again allowed to recover. A sexivalent chrome layer is plated onto the bright finish layer of Ni, and the thrice-plated base metal is allowed to recover.

After plating of the base metal is complete, the portion of the part to be coated is placed in a cavity of a molding die and clamped. A polymer material is melted and injected into the cavity where the polymer material undergoes a dwell period. During the dwell period, the polymer material is cooled (for thermoplastics) or cured (for thermosets) thereby forming a polymer coating on the plated base metal. The shape of the polymer coating corresponds to the shape of the die cavity. The die is opened, and the part is ejected.

Although injection molding generally produces a seat belt device part of sufficient quality, injection molding causes inefficiencies in the manufacturing process. For example, the cycle time of the injection molding process (i.e., clamping, injection, dwell, die opening, part removal) limits the speed of the manufacturing process and the overall production capacity. Additionally, injection molding requires a die and an injection molding machine, which require substantial capital investment. Moreover, production of higher quality parts may require multiple molding machines, a die for each molding machine, and peripheral fixtures. Finally, the die cavity must be appropriately shaped for each part model so that the coated portion of the part has the desired final form/shape. Thus, a new die is required whenever there is a part model change.

### SUMMARY

According to an aspect of the present invention, a seat belt device part includes a substrate and a coating disposed on a portion of the substrate. The coating is configured to contact a seat belt webbing. The coating is formed of a material configured to be deposited on the substrate by a powder coating process.

According to another aspect, a method of coating a seat belt device part includes providing a substrate; masking a portion of the substrate; setting the substrate in a powder coating apparatus; preheating the substrate; powder coating the substrate with a coating material to form a coating on an unmasked portion of the substrate; heating the coated substrate; cooling the coated substrate; removing the coated substrate from the powder coating apparatus; and unmasking the coated substrate.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of an embodiment of a seat belt device part according to the present invention;

FIG. 2A is a top plan view of the seat belt device part of FIG. 1 showing an uncoated substrate with an area to be powder coated in cross hatch;

FIG. 2B is a top plan view of the substrate of FIG. 2A after the substrate has been powder coated;

FIG. 3 is a cross-sectional side view of the seat belt device part of FIG. 1 taken along a centerline of the seat belt device part;

FIG. 4 is a block diagram of a method of powder coating a seat belt device part according to an embodiment of the present invention;

FIG. 5A is a top plan view of a conventional seat belt device part showing an uncoated substrate; and

FIG. 5B is a top plan view of the substrate of FIG. 5A after the substrate has been coated by injection molding.

### DETAILED DESCRIPTION

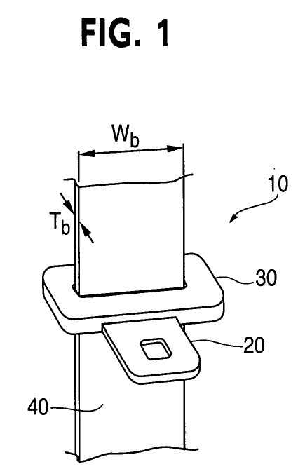

Embodiments of the present invention will be described below with reference to FIGS. 1-4.

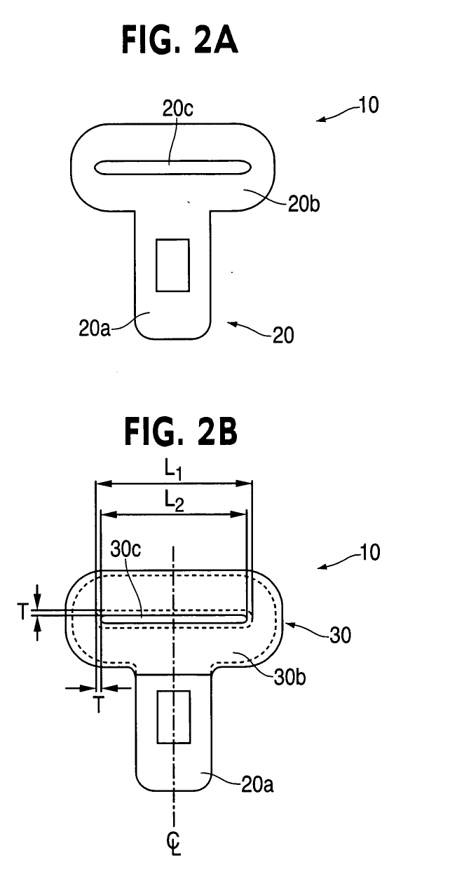

As shown in FIG. 1, a seat belt device part 10 includes a substrate 20 and a coating 30. The seat belt device part 10 shown in FIG. 1 is a tongue for connecting a seat belt webbing 40 to a buckle. The present invention, however, is not limited to such tongues. Rather, the invention applies to any seat belt device part that interacts with the seat belt webbing 40, such as a deflection device for changing a direction of the webbing 40, a seat belt anchor, and other related parts, e.g., as shown in FIG. 2 of U.S. Pat. No. 6,715,792, incorporated by reference herein.

According to an embodiment, the substrate 20 includes a base metal (e.g., steel) onto which one or more layers of plating are applied as a surface treatment. The layers of plating may include, for example, chromium plating, alloy plating (e.g., Sn or Ni alloy plating), and phosphoric salt film. In an exemplary embodiment, the plating may have one or more layers of Ni coated with a final layer of sexivalent chrome or an Sn/Ni alloy as described in U.S. Provisional Patent Application Ser. No. 60/555,961, incorporated by reference herein.

As shown in FIG. 2A, the substrate 20 includes a portion 20a configured to engage a seat belt buckle (not shown), a portion 20b to be coated with the coating 30, and an aperture 20c configured to receive the webbing 40. As shown in FIG. 1, the webbing 40 passes through the aperture 20c so that the part 10 can slide along the webbing 40. As shown in FIG. 2B, the coating 30 is disposed on the portion 20b of the substrate 20 to form a grip portion 30b that is gripped by a hand of a user when inserting the uncoated portion 20a of the substrate 20 into the buckle. The coating 30 includes an aperture 30c that coincides with the aperture 20c of the substrate 20.

The shape of the substrate 20 (shown in FIG. 2A) is preferably substantially similar to a desired final shape of the part 10 (shown in FIG. 2B). To achieve the shape of the substrate 20, the base metal of the substrate 20 may be formed by any appropriate metal forming process, such as stamping or punching, but is preferably formed by press molding. The plating and the coating 30 conform to the shape of the substrate 20 when applied. Thus, the part 10 has the desired final shape after the coating 30 is applied to the substrate 20 so that the need for a specially shaped die is eliminated.

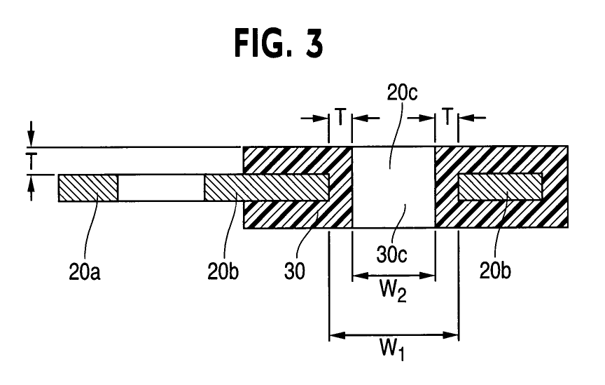

In an exemplary embodiment, the aperture 20c of the substrate 20 has a length L₁ and a width W₁ that are only slightly larger than a length L₂ and a width W₂ of the aperture 30c of the coating 30. As can be seen in FIG. 2B, the length L₁ is greater than the length L₂ by approximately two times a thickness T of the coating 30. Similarly, as shown in FIG. 3, the width W₁ is greater than the width W₂ by approximately two times the thickness T of the coating 30.

Additionally, the length L₂ and the width W₂ of the aperture 30c may substantially correspond to a width W_{b} and a thickness T_{b} of the webbing 40 so that the aperture 30c provides sufficient clearance for the webbing 40 to smoothly pass through the aperture 30c but does not provide enough space for the webbing 40 to twist. According to an embodiment, the thickness T of the coating 30 is about 400 μm or greater. In a preferred embodiment, the thickness T ois about 400 μm to 1200 μm.

The coating 30 may be made of any material that is capable of being applied to the substrate 20 by a powder coating process and that enables the webbing 40 to move smoothly over the coating 30. The coating material must be able to withstand friction from the webbing 40 and must have low abrasiveness so that the webbing 40 is not damaged or abraded as the webbing 40 travels over the coating 30. The coating 30 may be a powder coating or a powder resin material that includes a polymer, such as a thermoplastic material (e.g., nylon, polypropylene, polyethylene, vinyl) or a thermosetting material (e.g., epoxy, polyester, acrylic). Exemplary thermoplastic materials include powdered paint with polyethylene powdered resin, powdered paint with polypropylene powdered resin, powdered paint with nylon powdered resin, and powdered paint with vinyl powdered resin. Exemplary thermosetting materials include powdered paint with epoxy powdered resin, powdered paint with polyester powdered resin, and powdered paint with acrylic powdered resin.

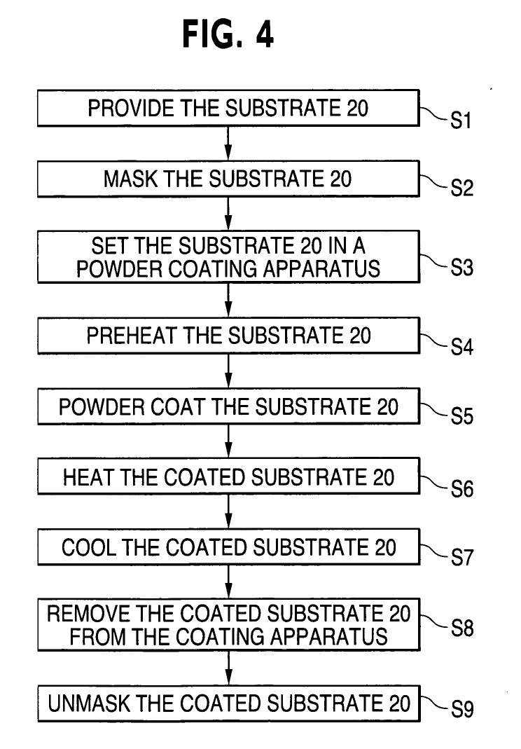

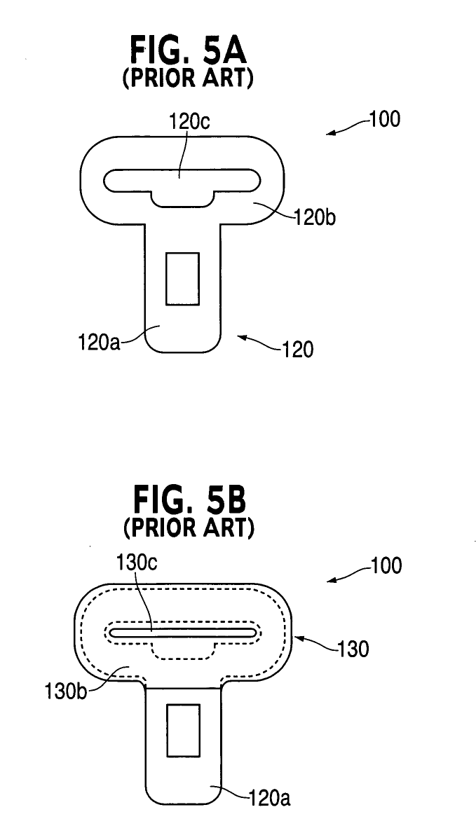

FIG. 4 details a method of applying a coating to a seat belt device part of the type disclosed in FIG. 1 according to an embodiment of the present invention. Specifically, in step S1, the substrate 20 is provided. In step S2, a portion 20a of the substrate 20 is masked with a suitable masking material, such as a powder coating masking tape (e.g., polyester tape having a coating of specially cured silicone adhesive that removes cleanly from the substrate 20 after application of the coating 30). In step S3, the substrate 20 is set in an appropriate powder coating apparatus. In step S4, the substrate 20 is preheated.

Application of the coating 30 occurs in step S5, where the substrate 20 is powder coated with the coating material to form the coating 30 on the unmasked portion (portion 20b) of the substrate 20. The coating may be applied continuously by any known and appropriate powder coating method. According to an embodiment, the powder coating method is an electrostatic powder coating method. In such a method, the coating material is imparted with a positive charge, and the substrate 20 is electrically grounded so that the positively charged particles of the coating material are strongly attracted to the substrate 20. In another embodiment, the powder coating method involves dipping the substrate 20 into a fluidized bed of the coating material.

In step S6, the substrate 20 is heated or maintained at an elevated temperature (i.e., “baked”) for a predetermined period of time so as to achieve a smooth surface. In an exemplary embodiment, the heat treatment of step S6 is conducted at a temperature of 200° C. for approximately 5 minutes. In step S7, the substrate 20 is cooled. In step S8, the substrate 20 is removed from the coating apparatus. Finally, in step S9, the substrate 20 is unmasked. In this manner, the part 10 is conveniently formed without the use of a die and an injection machine.

The method shown in FIG. 4 may also include a pre-treatment step where the substrate 20 is pre-treated to ensure that the portion 20a of the substrate 20 is clean and substantially free of contaminants. For example, the substrate 20 may be passed through a series of spray chambers where alkaline cleaners, iron or zinc phosphate conversion coatings, and rinses are applied. Additionally, surface scales may be removed by barrel polishing. Pre-treatment improves adhesion of the coating 30 to the substrate 20.

According to an embodiment, the coating material includes a thermoplastic nylon powdered resin. In step S4, the substrate 20 is preheated to about 290° C. The substrate 20 is dipped into a fluidized bed of the coating material to form a coating having a thickness of about 610 μm.

According to another embodiment, the coating material again includes a thermoplastic nylon powdered resin. In step S4, the substrate 20 is preheated to about 350° C. The substrate 20 is dipped into a fluidized bed of the coating material to form a coating having a thickness of about 1100 μm.

According to another embodiment, the coating material includes a thermoplastic vinyl powdered resin. In step S4, the substrate 20 is preheated to about 290° C. The substrate 20 is dipped into a fluidized bed of the coating material to form a coating having a thickness of about 600 μm.

According to another embodiment, the coating material includes a thermoplastic polyethylene powdered resin. In step S4, the substrate 20 is preheated to about 290° C. The substrate 20 is dipped into a fluidized bed of the coating material to form a coating having a thickness of about 500 μm.

According to another embodiment, the coating material includes a thermosetting epoxy powdered resin. In step S4, the substrate 20 is preheated to about 220° C. The substrate 20 is electrostatically powder coated to form a coating having a thickness of about 700 μm.

Thus, according to embodiments of the present invention, a powder coated seat belt device part that interacts with a seat belt webbing and a method of coating the part are provided. The powder coated part has the same functionality as a conventional injection molded part, but the powder coating enables continuous and faster production (e.g., mass production speed) and lower capital investment. Additionally, the powder coating process does not require use of a specially shaped die. Manufacturability of the powder coated part is thereby improved because parts with different shapes may be produced without the use of multiple dies (i.e., by changing the shape of the base metal). Moreover, because the base metal of the seat belt device part is press molded substantially into the desired final shape of the seat belt device part, the amount of raw material required to form the coating is reduced.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A seat belt device part, comprising:
a substrate; and
a coating disposed on a portion of the substrate configured to contact a seat belt webbing, and
wherein the coating is formed of a material configured to be deposited on the substrate by a powder coating process.

2. The seat belt device part of claim 1, wherein the substrate comprises metal.

3. The seat belt device part of claim 1, wherein a thickness of the coating is about 400 μm or greater.

4. The seat belt device part of claim 1, wherein a thickness of the coating is about 400 μm to 1200 μm.

5. The seat belt device part of claim 1, wherein the material comprises a polymer.

6. The seat belt device part of claim 1, wherein the material comprises a thermoplastic resin.

7. The seat belt device part of claim 6, wherein the thermoplastic resin comprises polyethylene powdered resin.

8. The seat belt device part of claim 6, wherein the thermoplastic resin comprises polypropylene powdered resin.

9. The seat belt device part of claim 6, wherein the thermoplastic resin comprises nylon powdered resin.

10. The seat belt device part of claim 6, wherein the thermoplastic resin comprises vinyl powdered resin.

11. The seat belt device part of claim 1, wherein the material comprises a thermoset resin.

12. The seat belt device part of claim 11, wherein the thermoset resin comprises epoxy powdered resin.

13. The seat belt device part of claim 11, wherein the thermoset resin comprises polyester powdered resin.

14. The seat belt device part of claim 11, wherein the thermoset resin comprises acrylic powdered resin.

15. A seat belt tongue comprising a coating formed of a material configured to be applied to the tongue by a powder coating process so that a thickness of the coating is about 400 μm or greater.

16. The tongue of claim 15, wherein the material comprises a polymer.

17. The tongue of claim 15, wherein the material comprises a thermoplastic resin.

18. The tongue of claim 15, wherein the material comprises a thermoset resin.

19. A method of coating a seat belt device part comprising the steps of:
providing a substrate;
masking a portion of the substrate;
setting the substrate in a powder coating apparatus;
preheating the substrate;
powder coating the substrate with a coating material to form a coating on an unmasked portion of the substrate;
heating the coated substrate;
cooling the coated substrate;
removing the coated substrate from the powder coating apparatus; and
unmasking the coated substrate.

20. The method according to claim 19, wherein the substrate comprises metal.

21. The method according to claim 20, wherein the step of providing the substrate includes forming the substrate into a shape that is substantially similar to a desired final shape of the coated substrate.

22. The method according to claim 21, wherein the step of forming the substrate includes press molding the substrate.

23. The method according to claim 19, wherein the step of powder coating the substrate includes electrostatic powder coating.

24. The method according to claim 19, wherein the step of powder coating the substrate includes dipping the substrate into a fluidized powder bed.

25. The method according to claim 19, further comprising the step of pre-treating the substrate so that a portion of the substrate to be coated is substantially free of contaminants.

26. The method according to claim 19, wherein the step of masking the substrate includes applying an adhesive tape to the substrate.

27. The method according to claim 19, wherein the step of preheating the substrate includes preheating the substrate to about 290° C., and wherein the coating has a thickness of about 610 μm.

28. The method according to claim 19, wherein the step of preheating the substrate includes preheating the substrate to about 290° C., and wherein the coating has a thickness of about 600 μm.

29. The method according to claim 19, wherein the step of preheating the substrate includes preheating the substrate to about 290° C., and wherein the coating has a thickness of about 500 μm.

30. The method according to claim 19, wherein the step of preheating the substrate includes preheating the substrate to about 350° C., and wherein the coating has a thickness of about 1100 μm.

31. The method according to claim 19, wherein the step of preheating the substrate includes preheating the substrate to about 220° C., and wherein the coating has a thickness of about 700 μm.

32. The method according to claim 19, wherein the step of heating the coated substrate includes maintaining the coated substrate at a temperature of about 200° C., for approximately 5 minutes.
